(19) United States
(12) Patent Application Publication
(10) Pub. No.: US 2026/0107100 A1
(43) Pub. Date: Apr. 16, 2026

(54) SYSTEMS AND METHODS FOR SOUND-BASED MONITORING OF A SPACE

(71) Applicant: Microchip Technology Inc., Chandler, AZ (US)

(72) Inventors: Arthur B. Eck, Gilbert, AZ (US); Patrick McFarland, Gilbert, AZ (US); Bomy Chen, Newark, CA (US); Steve Nagel, Chandler, AZ (US)

(73) Assignee: Microchip Technology Inc., Chandler, AZ (US)

(21) Appl. No.: 19/196,894

(22) Filed: May 2, 2025

Related U.S. Application Data
(60) Provisional application No. 63/705,926, filed on Oct. 10, 2024.

(51) Int. Cl. H04R 29/00; G06F 3/16

(52) U.S. Cl. CPC H04R 29/004; G06F 3/167; H04R 29/001

(57) ABSTRACT

A system includes a first sound detection device control circuitry including a processor and at least one memory device storing logic instructions executable by the processor to perform a process to locate the first sound detection device, including (a) testing a first location for the first sound detection device by receiving sound data generated by the first sound detection device at the first location, analyzing the sound data to identify sound generated by a first sound-generating object, and analyzing a quality of the first location based on the analysis of the sound data, and (b) based on the analyzed quality of the first location, outputting a user notification including at least one of (a) an instruction to relocate the first sound detection device or (b) an instruction to add a second sound detection device in the defined space.

### RELATED APPLICATION

This application claims priority to commonly owned U.S. Provisional Ser. No. 63/705,926 filed Oct. 10, 2024, the entire contents of which are hereby incorporated by reference for all purposes.

### TECHNICAL FIELD

The present disclosure relates to systems and method for sound-based monitoring of a space, for example to monitor the operation of home appliances and/or other sound generating objects.

### BACKGROUND

There are various sounds in residences that indicate a problem, for example a loss of water due to a water leak or faucet left on, a loss of energy, a faulty appliance, inefficient HVAC operation, or property damage, or other unwanted expense.

There is a need for improved systems and methods for identifying and notifying a user of problems in a residence.

### SUMMARY

Examples of the present disclosure provide systems and methods for sound-based identifications of problems in a residence. Some examples systems and methods for systemically placing microphones in a residence, and use software and machine learning methods to train to listen for problems.

Some examples provide systems and methods to help reduce or prevent wasteful energy and water costs, water damage (e.g., due to a leak), failing or faulty appliances (e.g., a refrigerator fault that may lead to food loss), irregular or faulty HVAC operation, etc.

Some examples provide a sound analysis system to detect problem sounds in a residence, which includes an application, e.g., hosted or presented on a smartphone or other computer, allowing a user to interface with the sound analysis system. In some examples, the user may provide feedback regarding sounds identified by the system, e.g., to confirm problems identified by the system or to indicate a false positive detection by the system, or to inform the system of a problem unidentified by the system (but identified by the user).

In some examples, the application includes a search dog feature allowing a user to move around a space with a mobile device to identify the source of audio data detected by the sound analysis system (e.g., audio data indicating a problem). As the user moves around the space, a microphone of the mobile device collects audio data and transmits the audio data to the sound analysis system (provided in the mobile device or communicatively connected to the mobile device), which compares the audio data to determine a physical relationship (e.g., distance) between the mobile device and the source of the problem audio data. Based on such comparison, the system may provide feedback to the user directing the user closer to the source of the problem audio data.

In some examples, the sound analysis system includes a library of appliance and home sound profiles. In some examples, the sound analysis system may reduce or minimize data fitting and maximize diagnostics. In some examples, the sound analysis system may use a single microphone for wide spectrum analysis. In other examples, the sound analysis system may use multiple microphones.

One aspect provides a system includes a first sound detection device control circuitry including a processor and at least one memory device storing logic instructions executable by the processor to perform a process to locate the first sound detection device, including (a) testing a first location for the first sound detection device by receiving sound data generated by the first sound detection device at the first location, analyzing the sound data to identify sound generated by a first sound-generating object, and analyzing a quality of the first location based on the analysis of the sound data, and (b) based on the analyzed quality of the first location, outputting a user notification including at least one of (a) an instruction to relocate the first sound detection device or (b) an instruction to add a second sound detection device in the defined space.

In some examples, the system includes logic instructions executable to, prior to testing the first location, determining the first location for the first sound detection device by receiving, via a user interface, location information for at least one sound-generating object in a defined space, the location information indicating a respective location of the at least one sound-generating object; determining the first location for the first sound detection device based on the received location information for the at least one sound-generating object; and outputting, via the user interface, the first location for the first sound detection device.

In some examples, the system includes logic instructions executable to test the first location for the first sound detection device by analyzing the first location for detecting sounds from each of multiple sound-generating objects in a sequential manner, wherein analyzing the first location for detecting sounds from each respective sound-generating object comprises: receiving sound data generated by the first sound detection device during a sound-generating operation of the respective sound-generating object; analyzing the received sound data generated by the first sound detection device positioned at the first location to identify sound generated by the respective sound-generating object; and analyzing a quality of the identified sound generated by the respective sound-generating object.

In some examples, the system includes the logic instructions executable to perform the process including: receiving, via the user interface, dimensions of the defined space; and generating a map of the defined space based at least on the received dimensions of the defined space, and locating the at least one sound-generating object in the map based on the received location information for the at least one sound-generating object.

In some examples, the system includes the logic instructions executable to perform a monitoring process after the process to locate the first sound detection device, the monitoring process including: identifying a fault condition associated with a respective sound-generating object based on sound data generated by the first sound detection device; and outputting a notification of the identified fault condition associated with the respective sound-generating object.

In some examples, the system includes the logic instructions executable to perform the monitoring process including: receiving user feedback indicating a rejection of the identified fault condition associated with the respective sound-generating object; and in response to receiving the rejection of the identified fault condition, adjusting at least one fault detection parameter for identifying the fault condition associated with the respective sound-generating object.

In some examples, the system includes the logic instructions executable to identify the fault condition associated with the respective sound-generating object including: receiving sound data generated by the first sound detection device; comparing the received sound data with reference sound data corresponding with the respective sound-generating object; and identifying the fault condition associated with the respective sound-generating object based on the comparison of the received sound data with the reference sound data.

In some examples, the system includes the logic instructions executable to identify the fault condition associated with the respective sound-generating object including: receiving sound data generated by the first sound detection device; identifying, from the received sound data, a sound indicating a defined operation or fault associated with the respective sound-generating object; determining a duration of the identified sound; and determining the duration of the identified sound exceeds a defined threshold duration for the identified sound.

In some examples, the system includes the logic instructions executable to identify the fault condition associated with the respective sound-generating object including: receiving sound data generated by the first sound detection device; identifying, from the received sound data, a sound indicating a defined operation or fault associated with the respective sound-generating object; determining a change in the identified sound over time; and identifying the fault condition associated with the respective sound-generating object based on the determined change in the identified sound over time.

In some examples, the first sound detection device includes circuitry to generate and output audible test signal, detect sound including reflected test signals comprising reflections of the audible test signals output by the respective sound detection device and reflected off respective structures, and generate test result signals based on the detected reflected test signals.

In some examples, the system includes logic instructions executable to, prior to testing the first location, determining the first location for the first sound detection device including: receiving, via a user interface, location information for at least one sound-generating object in a defined space, the location information indicating a respective location of the at least one respective sound-generating object; receiving test result signals generated by the first sound detection device positioned in at least one test location; determining the first location for the first sound detection device based on (a) the received location information for the at least one sound-generating object and (b) the received test result signals generated by the first sound detection device positioned in at least one test location; and outputting, via the user interface, the first location for the first sound detection device.

Another aspect provides a method, including performing, by control circuitry of a sound-based monitoring system, a process to locate a first sound detection device, including (a) testing a first location for the first sound detection device by receiving sound data generated by the first sound detection device positioned at the first location; analyzing the received sound data generated by the first sound detection device positioned at the first location to identify sound generated by a first sound-generating object; and analyzing a quality of the first location based on the analysis of the received sound data, and (b) based on the analyzed quality of the first location, outputting via a visual or audible output device, a user notification including at least one of (a) an instruction to relocate the first sound detection device or (b) an instruction to add a second sound detection device in the defined space.

In some examples, the method includes, prior to testing the first location, determining the first location for the first sound detection device by: receiving, via a user interface, location information for at least one sound-generating object in a defined space, the location information indicating a respective location of the at least one sound-generating object; determining the first location for the first sound detection device based on the received location information for the at least one sound-generating object; and outputting, via the user interface, the first location for the first sound detection device.

In some examples, testing the first location for the first sound detection device includes: analyzing the first location for detecting sounds from each of multiple sound-generating objects in a sequential manner, wherein analyzing the first location for detecting sounds from each respective sound-generating object comprises: receiving sound data generated by the first sound detection device during a sound-generating operation of the respective sound-generating object; analyzing the received sound data generated by the first sound detection device positioned at the first location to identify sound generated by the respective sound-generating object; and analyzing a quality of the identified sound generated by the respective sound-generating object.

In some examples, performing the process includes receiving, via the user interface, dimensions of the defined space, and generating a map of the defined space based at least on the received dimensions of the defined space, and locating the at least one sound-generating object in the map based on the received location information for the at least one sound-generating object.

In some examples, the method includes performing a monitoring process after the process, the monitoring process including identifying a fault condition associated with a respective sound-generating object based on sound data generated by the first sound detection device, and outputting a notification of the identified fault condition associated with the respective sound-generating object.

In some examples, performing the monitoring process includes receiving user feedback indicating a rejection of the identified fault condition associated with the respective sound-generating object, and in response to receiving the rejection of the identified fault condition, adjusting at least one fault detection parameter for identifying the fault condition associated with the respective sound-generating object.

In some examples, identifying the fault condition associated with the respective sound-generating object includes receiving sound data generated by the first sound detection device, comparing the received sound data with reference sound data corresponding with the respective sound-generating object, and identifying the fault condition associated with the respective sound-generating object based on the comparison of the received sound data with the reference sound data.

In some examples, identifying the fault condition associated with the respective sound-generating object includes receiving sound data generated by the first sound detection device; identifying, from the received sound data, a sound indicating a defined operation or fault associated with the respective sound-generating object; determining a duration of the identified sound; and determining the duration of the identified sound exceeds a defined threshold duration for the identified sound.

In some examples, the first sound detection device includes circuitry to: generate and output audible test signals; detect sound including reflected test signals comprising reflections of the audible test signals output by the respective sound detection device and reflected off respective structures; and generate test result signals based on the detected reflected test signals; and wherein the method comprises, prior to testing the first location, determining the first location for the first sound detection device by: receiving, via a user interface, location information for at least one sound-generating object in a defined space, the location information indicating a respective location of the at least one respective sound-generating object; receiving test result signals generated by the first sound detection device positioned in at least one test location; determining the first location for the first sound detection device based on (a) the received location information for the at least one sound-generating object and (b) the received test result signals generated by the first sound detection device positioned in at least one test location; and outputting, via the user interface, the first location for the first sound detection device.

### BRIEF DESCRIPTION OF THE DRAWINGS

Example aspects of the present disclosure are described below in conjunction with the figures, in which:

FIG. 1 shows an example system for positioning one or more sound detection devices in a space including one or more sound-generating objects (SGOs), for example to detect fault conditions associated with such SGO(s);

FIG. 2 is a flowchart of an example method, e.g., implemented by the example system shown in FIG. 1, for positioning one or more microphones in a room including one or more SGOs to monitor for possible fault conditions associated with such SGOs;

FIG. 3 is a flowchart of an example method, e.g., implemented by the example system shown in FIG. 1, for positioning one or more combination microphone/speaker device in a room including one or more SGOs to monitor for possible fault conditions associated with such SGOs;

FIG. 4A is a flowchart of an example method for receiving user feedback to either confirm a fault condition identified by a sound analysis system (e.g., the example system shown in FIG. 1) or to indicate a false positive detection;

FIG. 4B is a flowchart of an example method for receiving user feedback inform a sound analysis system (e.g., the example system shown in FIG. 1) of a fault condition not identified by the sound analysis system;

FIG. 4C is a flowchart of an example method for providing a search function by a sound analysis system (e.g., the example system shown in FIG. 1) allowing a user to move around a space with a mobile device (e.g., smartphone) to identify the source of sound detected by the sound analysis system; and

FIG. 5 shows an example room map generated by a sound analysis system (e.g., the example system shown in FIG. 1), for example, based on room dimensions and SGO information entered by a user.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

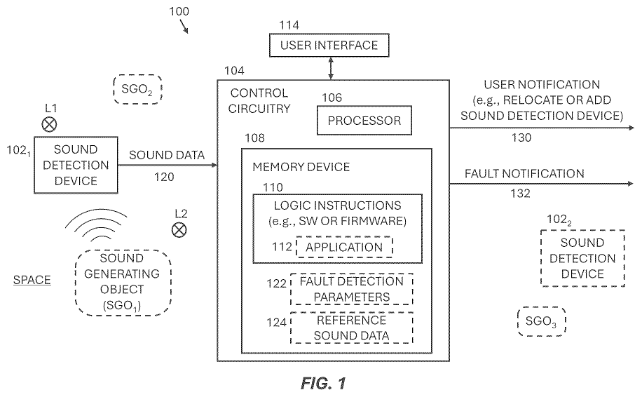

FIG. 1 shows an example sound analysis system 100 for positioning one or more sound detection devices 102 in a space, for example to effectively “listen” to one or more sound-generating objects, or “SGOs,” for example to detect fault conditions associated with such SGO(s). The example system 100 includes at least a first sound detection device 102₁ and control circuitry 104.

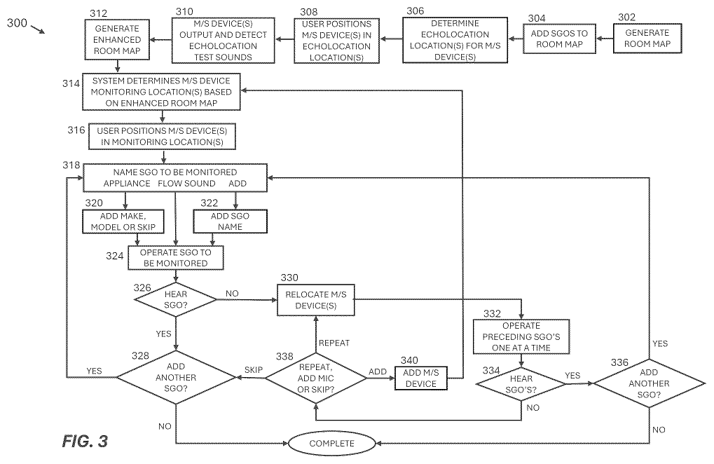

The first sound detection device 102₁ may comprise, for example, a microphone or a combination microphone/speaker device configured to both generate sound and detect sound. The first sound detection device 102₁ may be configured to detect sound, e.g., including sound generated by at least one sound-generating object (SGO), e.g., during sound-generating operation of respective SGOs, and generate sound data 120 output to control circuitry 104 for analysis, as discussed below. As discussed below with reference to FIG. 3, in examples in which the first sound detection device 102₁ comprises a combination microphone/speaker device, the first sound detection device 102₁ may generate and output audible test signals, detect sound including reflected test signals comprising reflections of the audible test signals output by the combination microphone/speaker device and reflected off respective structures, and generate test result signals based on the detected reflected test signals, which test result signals may be analyzed by control circuitry 104 for analyzing the location of the first sound detection device 102₁.

A sound-generating object (SGO) may include any system or device that produces sound during a normal or faulty operation of the system or device. Example types of SGOs include appliances, faucets, drains, toilets, fans, HVAC blowers or furnaces, HVAC inlets or outlets (e.g., creating sounds of air passing through an HVAC register), etc.

The control circuitry 104 may include a processor 106 and a memory device 108 storing logic instructions 110, e.g., embodied as firmware and/or software, executable by the processor 106 to perform a locating process to locate the first sound detection device 102₁, e.g., to effectively listen to and analyze the first sound-generating object SGO₁. Such locating process performed by the logic instructions 110 may include testing a first location L1 for the sound detection device 102₁ by: (a) receiving sound data 120 generated by the sound detection device 102₁ positioned at the first location L1 (e.g., sound data 120 including or indicating detected sounds from the first sound-generating object SGO₁ and/or other SGO or SGOs), (b) analyzing the received sound data 120 to identify sound generated by the first sound-generating object SGO₁ (e.g., filtered or separated from other detected noise), and (c) analyzing a quality of the first location L1 of the sound detection device 102₁ based on the analysis of sound data 120. The logic instructions 110 may be further executable to output a user notification 130 based on the analyzed quality of the first location L1 of the sound detection device 102₁. The user notification 130 may include, for example, at least one of (a) an instruction to relocate the first sound detection device 102₁, for example to a second location L2 (e.g., for improved detection of sound output by the first sound-generating object SGO₁ and/or other sound-generating objects SGOs), or (b) an instruction to add a second sound detection device 102₂ in the defined space.

In some examples, logic instructions 110 may be further executable to determine the first location L1 for the first sound detection device 102₁ prior to testing the first location 102₁, by a process including (a) receiving, via a user interface 114 (e.g., a smart phone, laptop, or other computer or dedicated user interface device), SGO location information indicating respective locations of respective sound-generating object SGO(s) in the defined space, (b) determining the first location L1 for the first sound detection device 102₁ based on the received SGO location information, and (c) outputting the first location L1 for the first sound detection device 102₁ via the user interface.

After determining an effective location for the first sound detection device 102₁ (and/or additional sound detection device(s) 102), logic instructions 110 may be further executable to perform a monitoring process based on received sound data 120 to detect fault conditions associated with respective SGOs, for example by comparing respective sound data 120 to one or more defined fault detection parameter 122 and/or reference sound data 124, e.g., stored in memory 108 or otherwise accessibly to control circuitry 104. Such monitoring process may include, for example, identifying a fault condition associated with a respective SGO based at least on sound data 120 generated by the first sound detection device 102₁, and outputting a notification signal 132 (e.g., for display or via the user interface 114) indicating the identified fault condition associated with the respective SGO.

A fault condition associated with an SGO may include any faulty or improper operation or state of the SGO, for example, a faulty operation of an appliance, an appliance operating in an “on” state beyond a defined time limit, a faucet running beyond a defined time limit, a gas or liquid leak, faulty operation of an HVAC system, an obstructed HVAC inlet or outlet, etc.

In some examples, logic instructions 110 may be executable to detect a fault condition associated with an SGO by comparing received sound data 120 from sound detection device(s) 102 with reference sound data 124 corresponding with the SGO, and identifying the fault condition associated with the respective sound-generating object based on the comparison of the received sound data 120 with the reference sound data 124.

In some examples, logic instructions 110 may be executable to detect a fault condition associated with an SGO by identifying, from sound data 120 generated from sound detection device(s) 102, a sound indicating a defined operation or fault associated with a respective SGO (e.g., running water from a faucet), determining a duration of the identified sound, comparing the sound duration with defined threshold corresponding with the identified sound (e.g., stored in memory 108), and identifying a fault condition if the duration of the identified sound exceeds the defined threshold duration.

In some examples, logic instructions 110 may be executable to detect a fault condition associated with an SGO by identifying, from sound data 120 generated from sound detection device(s) 102, a sound indicating a defined operation or fault associated with a respective SGO, determining a change in the identified sound over time, and identifying a fault condition based on the determined change in the identified sound over time, for example if the change in sound exceeds a defined threshold stored in memory 108.

In some examples, a user may review an identified fault condition indicated by the notification signal 132, e.g., by listening to or otherwise analyzing the respective SGO, and may confirm or reject (e.g., as a false positive) the fault condition. In such example, the user may input user feedback to system 100 (e.g., via the user interface 114) indicating a confirmation or rejection of the identified fault condition associated with the respective SGO. In the event of user feedback indicating a rejection of an identified fault condition, control circuitry 104 may adjust at least one fault detection parameter 122 used by control circuitry 104 for identifying the respective type of fault condition.

In some examples, logic instructions 110 discussed herein may be at least partially embodied as an application (or “app”) 112 allowing user interaction, e.g., via user interface 114.

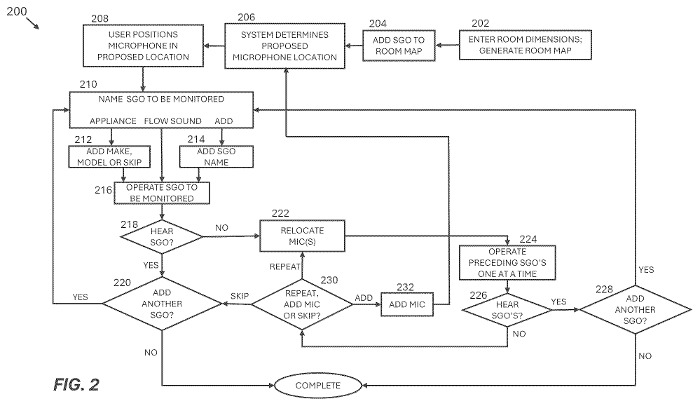

FIG. 2 is a flowchart of an example method 200 for positioning one or more sound detection devices 102, in this example one or more microphones, in a room including one or more SGOs to monitor for possible fault conditions associated with such SGOs. The example method 200 may be implemented using example sound analysis system 100 shown in FIG. 1 and discussed above, for example using an application 112 (or other implementation of logic instructions 110) presented on a user's smartphone, laptop, or other computer device.

At 202, a user may enter dimensions for the room, for example by entering dimensions via user interface 114 or using a measuring tool integrated in the system 100 (e.g., a laser-based distance measurement tool). The application 112 may generate a map of the room based on the entered room dimensions, which map may be displayed to the user via user interface 114 (e.g., display screen). In some examples, the user may enter other physical obstructions or objects that may influence sound detection to the room map, for example furniture.

At 204, the user may add a selected SGO, for example a dishwasher, to the room map generated by application 112. For example, the user may select “dishwasher” from a list of SGO types presented by application 112, and then locate the dishwasher in the room map, for example by clicking a location on the displayed room map, or by dragging and dropping a dishwasher icon to the relevant location in the room. In some examples, the user may add a single SGO to the room map and proceed with the following process to locate one or more microphones (sound detection devices 102) in the room. In other examples, the user may enter multiple SGOs to the room map before proceeding to located microphone(s) in the room.

At 206, the application 112 may determine a proposed location to place a microphone (sound detection device 102) based on the room map and any SGO(s) located in the room as discussed above. For example, the application 112 may calculate a best microphone location for detecting sound from a particular SGO, for example the dishwasher discussed above, based on an acoustic analysis of the room map. The application 112 may display or otherwise indicate the proposed microphone location to the user. In another implementation, the application 112 may calculate a best microphone location for detecting sound from multiple SGOs (or all SGOs) in the room.

At 208, the user may physically position a microphone in the proposed location determined at 206.

At 210, the user may name or otherwise identify the particular SGO to be monitored by the microphone positioned at 208, for example by entering identification information via user interface 114. For example, as shown at 212, for an appliance (e.g., dishwasher discussed above), the user may enter the make, model and/or other identifying information for the appliance. For a new type of SGO (e.g., not include in a list of SGO types presented by application 112), the user may enter a name and/or type of the SGO at 214.

At 216, the user may then operate the particular SGO (e.g., dishwasher) such that the SGO produces sound.

At 218, the application 112 may determine whether the microphone 102 can effectively hear the particular SGO, e.g., by comparing sounds detected by the microphone 102 before and after starting operation of the SGO. The application 112 may also analyze a quality or other parameter(s) of the detected sound from the particular SGO by the microphone 102.

If at 218 the microphone 102 can effectively hear the particular SGO (e.g., according to relevant threshold values), the method may proceed to 220 to add another SGO to the room map and return to 210 to name and the new SGO and test whether the microphone 102 can effectively hear the new SGO.

Alternatively, if at 218 the microphone 102 cannot effectively hear the particular SGO (e.g., according to relevant threshold values), at 222 the application 112 may instruct the user to reposition the microphone 102, e.g., closer to the particular SGO. At 224, the application 112 may then instruct the user to operate the particular SGO (and/or other previously added SGOs) one at a time.

At 226, the application 112 may determine whether the microphone 102 (and/or other previously added microphone(s) 102) can effectively hear all SGOs that have been added (e.g., according to relevant threshold values). If yes, the method may proceed to 228 to add another SGO to the room map. If not, the method may proceed to 230 to either repeat the sound test, instruct the user to reposition one or more microphones 102 and repeat the sound test, or add another microphone 102 (at 232).

FIG. 3 is a flowchart of an example method 300 for positioning one or more sound detection devices 102, in this example one or more combination microphone/speaker devices (e.g., in contrast to example method 200 discussed above for positioning microphone devices), in a room including one or more SGOs to monitor for possible fault conditions associated with such SGOs. The example method 300 may be implemented using example sound analysis system 100 shown in FIG. 1 and discussed above, for example using an application 112 (or other implementation of logic instructions 110) presented on a user's smartphone, laptop, or other computer device. A combination microphone/speaker device may include any suitable hardware and/or circuitry to both generate sound and detect sound.

At 302, a user may enter dimensions for the room, for example by entering dimensions via user interface 114 or using a measuring tool integrated in the system 100 (e.g., a laser-based distance measurement tool), which map may be displayed to the user via user interface 114 (e.g., display screen), as discussed above regarding step 202 of example method 200.

At 304, the user may add and locate a selected SGO, for example a dishwasher, to the room map generated by application 112, e.g., as discussed above regarding step 204 of example method 200.

At 306, the application 112 may determine proposed echolocation test location(s) to place one or more combination microphone/speaker devices, or “M/S devices” (each embodying a sound detection device 102 in this example) for echolocation-based mapping of the room, based on the room map generated based on the user input. The application 112 may display or otherwise indicate the proposed echolocation test locations to the user.

At 308, the user may physically position the one or more M/S devices 102 in the echolocation test location(s) determined at 306.

At 310, application 112 may control the M/S device(s) 102 to output and detect test sounds for echolocation based mapping of the room. At 312, the application 112 may generate an enhanced room map based on the detected test sounds by the M/S device(s) 102 at 310. For example, the application 112 may identify and locate physical structures in the room, which may include structures included in the room map generated at 302 and/or additional structures. In some examples, the application 112 may generate a 2D room map based on user input at 302, and generate an enhanced 3D room map based on echolocation mapping at 312.

At 314, the application 112 may determine proposed monitoring location(s) to place one or more M/S device(s) 102 based on the enhanced room map and any SGOs located in the room. For example, the application 112 may calculate a best location or location for detecting sound from one or more SGOs, for example the dishwasher discussed above, based on an acoustic analysis of the enhanced room map. The application 112 may display or otherwise indicate the proposed M/S device monitoring location(s) to the user.

At 316, the user may physically position the M/S device(s) 102 in the proposed monitoring location(s) determined at 314.

At 318, the user may name or otherwise identify a particular SGO to be monitored by the M/S device(s) 102 positioned at 316, for example by entering identification information via user interface 114. For example, as shown at 320, for an appliance (e.g., dishwasher discussed above), the user may enter the make, model and/or other identifying information for the appliance. For a new type of SGO (e.g., not include in a list of SGO types presented by application 112), the user may enter a name and/or type of the SGO at 322.

At 324, the user may then operate a particular SGO (e.g., dishwasher) such that the SGO produces sound.

At 326, the application 112 may determine whether the M/S device(s) 102 can effectively hear the particular SGO, e.g., by comparing sounds detected by the M/S device(s) 102 before and after starting operation of the SGO. The application 112 may also analyze a quality or other parameter(s) of the detected sound from the particular SGO by the M/S device(s) 102.

If at 326 the M/S device(s) 102 can effectively hear the particular SGO (e.g., according to relevant threshold values), the method may proceed to 328 to add another SGO to the room map and return to 318 to name and the new SGO and test whether the M/S device(s) 102 can effectively hear the new SGO.

Alternatively, if at 326 the M/S device(s) 102 cannot effectively hear the particular SGO (e.g., according to relevant threshold values), at 330 the application 112 may instruct the user to reposition one or more M/S devices 102, e.g., closer to the particular SGO. At 332, the application 112 may then instruct the user to operate the particular SGO (and/or other previously added SGOs) one at a time.

At 334, the application 112 may determine whether the M/S device(s) 102 can effectively hear all SGOs that have been added (e.g., according to relevant threshold values). If yes, the method may proceed to 336 to add another SGO to the room map. If not, the method may proceed to 338 to either repeat the sound test, instruct the user to reposition one or more M/S device(s) 102 and repeat the sound test, or add another M/S device 102 (at 340).

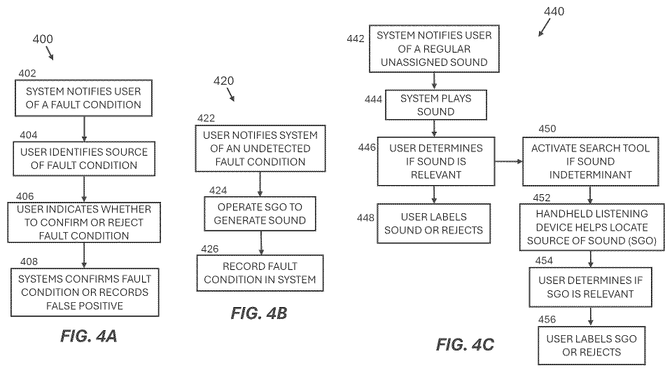

FIG. 4A is a flowchart of an example method 400 for receiving user feedback to either confirm a fault condition identified by the example sound analysis system 100 shown in FIG. 1 or to indicate a false positive detection. The example method 400 may be implemented using control circuitry 104 of system 100, for example using an application 112 (or other implementation of logic instructions 110) presented on a user's smartphone, laptop, or other computer device.

At 402, the system 100 may identify a fault condition associated with a respective SGO based on sound data generated by one or more sound detection device 102, and output a user notification of the identified fault condition, e.g., via a display, speaker, or other user interface 114. At 404, a user may evaluate the identified fault condition, for example by operating and/or otherwise examining the SGO to determine whether or not a fault condition does in fact exist.

At 406, the user may input user feedback to system 100 (e.g., via user interface 114) indicating a confirmation or rejection of the identified fault condition associated with the SGO. The system 100 may then confirm or reject the identified fault condition based on the user input at 408. For example, in the event of user input indicating a confirmation of the identified fault condition, control circuitry 104 may record fault detection parameters 122 associated with the identified fault condition, e.g., for future detection of a similar fault condition associated with the respective SGO or other SGO. Alternatively, in the event of user input indicating a rejection of the identified fault condition (i.e., indicating a false positive), control circuitry 104 may adjust at least one fault detection parameter 122 for identifying the fault condition, e.g., to avoid future false positive detection of a similar fault condition.

FIG. 4B is a flowchart of an example method 420 for receiving user feedback to inform the sound analysis system 100 of a fault condition not identified by the system 100. The example method 400 may be implemented using control circuitry 104 of system 100, for example using an application 112 (or other implementation of logic instructions 110) presented on a user's smartphone, laptop, or other computer device.

At 422, a user may input user feedback to system 100 (e.g., via user interface 114) indicating a fault condition associated with the SGO that was not identified by the system 100 (i.e., a false negative by system 10). For example, the user may identify the particular SGO and enter a description of the fault condition. If possible, at 424, the user may operate the SGO in a manner that produces the sound associated with the fault condition, which sound may be detected by one or more sound detection device 102. At 426, system 100 may adjust at least one fault detection parameter 122 for identifying the fault condition (previously undetected by system 100), e.g., for future detection of a similar fault condition associated with the respective SGO or other SGO.

FIG. 4C is a flowchart of an example method 440 for providing a search function by the example sound analysis system 100 shown in FIG. 1, which may allow a user to move around a space with a mobile device (e.g., smartphone) to identify the source of new sound detected by the system 100. The example method 440 may be implemented using control circuitry 104 of system 100, for example using an application 112 (or other implementation of logic instructions 110) presented on a user's smartphone, laptop, or other computer device.

At 442, system 100 may identify a recurring unassigned sound, i.e., a sound that is not assigned to any SGO in the relevant space, and output a user notification of the identified unassigned sound, e.g., via a display, speaker, or other user interface 114. At 444, system 100 may output the unassigned sound, e.g., via a speaker of an M/S device 102 or via a speaker of the user's smartphone, laptop, or other computer device.

At 446, the user may attempt to identify the sound and determine whether the sound is relevant. If the user can identify the sound, at 448 the user may label and/or reject the sound (as being irrelevant), e.g., via user interface 114. If the user cannot identify the sound, or cannot identify the source of the sound, at 450 the user may active a search tool provided by control circuitry 104 (e.g., application 112), e.g., by selecting the search tool via the user interface.

At 452, the user may move around the room carrying a mobile device hosting or having access to control circuitry 104 (e.g., application 112), wherein a microphone of the mobile device may listen for the unassigned sound. If the mobile device identifies (i.e., “hears”) the unassigned sound, the control circuitry 104 (e.g., application 112) may guide the user to the location of the source of the sound (SGO). At 454, upon discovering the source of the unassigned sound, the user may determine whether the SGO is relevant, e.g., an SGO to be monitored by system 100. At 456, the user may add and/or reject the SGO (as being irrelevant), e.g., via user interface 114.

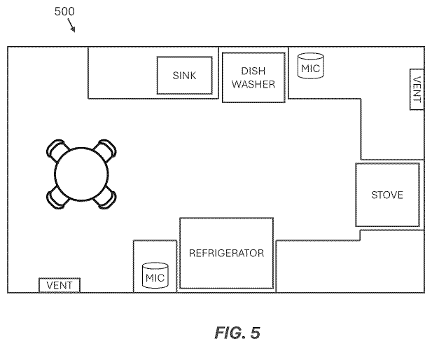

FIG. 5 shows an example room map 500 generated by the example sound analysis system 100 shown in FIG. 1, including various example SGOs (sink, dishwasher, stove, refrigerator, and HVAC vents) and two example microphones (MICs) located in the room. In some example, the example room map 500 may be displayed on a display screen of user interface 114, e.g., a display of a smartphone, tablet, or laptop computer.

1. A system, comprising:
a first sound detection device; and
control circuitry, comprising:
a processor; and
at least one memory device storing logic instructions executable by the processor to perform a process to locate the first sound detection device in a defined space, including:
testing a first location for the first sound detection device by:
receiving sound data generated by the first sound detection device positioned at the first location;
analyzing the received sound data generated by the first sound detection device positioned at the first location to identify sound generated by a first sound-generating object;
analyzing a quality of the first location based on the analysis of the received sound data; and
based on the analyzed quality of the first location, outputting a user notification including at least one of (a) an instruction to relocate the first sound detection device or (b) an instruction to add a second sound detection device in the defined space.

2. The system of claim 1, comprising logic instructions executable to, prior to testing the first location, determining the first location for the first sound detection device by:
receiving, via a user interface, location information for at least one sound-generating object in the defined space, the location information indicating a respective location of the at least one sound-generating object;
determining the first location for the first sound detection device based on the received location information for the at least one sound-generating object; and
outputting, via the user interface, the first location for the first sound detection device.

3. The system of claim 1, comprising logic instructions executable to test the first location for the first sound detection device by:
analyzing the first location for detecting sounds from each of multiple sound-generating objects in a sequential manner, wherein analyzing the first location for detecting sounds from each respective sound-generating object comprises:
receiving sound data generated by the first sound detection device during a sound-generating operation of the respective sound-generating object;
analyzing the received sound data generated by the first sound detection device positioned at the first location to identify sound generated by the respective sound-generating object; and
analyzing a quality of the identified sound generated by the respective sound-generating object.

4. The system of claim 1, comprising the logic instructions executable to perform the process including:
receiving, via the user interface, dimensions of the defined space; and
generating a map of the defined space based at least on the received dimensions of the defined space, and locating the at least one sound-generating object in the map based on the received location information for the at least one sound-generating object.

5. The system of claim 1, comprising the logic instructions executable to perform a monitoring process after the process to locate the first sound detection device, the monitoring process including:
identifying a fault condition associated with a respective sound-generating object based on sound data generated by the first sound detection device; and
outputting a notification of the identified fault condition associated with the respective sound-generating object.

6. The system of claim 5, comprising the logic instructions executable to perform the monitoring process including:
receiving user feedback indicating a rejection of the identified fault condition associated with the respective sound-generating object; and
in response to receiving the rejection of the identified fault condition, adjusting at least one fault detection parameter for identifying the fault condition associated with the respective sound-generating object.

7. The system of claim 5, comprising the logic instructions executable to identify the fault condition associated with the respective sound-generating object including:
receiving sound data generated by the first sound detection device;
comparing the received sound data with reference sound data corresponding with the respective sound-generating object; and
identifying the fault condition associated with the respective sound-generating object based on the comparison of the received sound data with the reference sound data.

8. The system of claim 5, comprising the logic instructions executable to identify the fault condition associated with the respective sound-generating object including:
receiving sound data generated by the first sound detection device;
identifying, from the received sound data, a sound indicating a defined operation or fault associated with the respective sound-generating object;
determining a duration of the identified sound; and
determining the duration of the identified sound exceeds a defined threshold duration for the identified sound.

9. The system of claim 5, comprising the logic instructions executable to identify the fault condition associated with the respective sound-generating object including:
receiving sound data generated by the first sound detection device;
identifying, from the received sound data, a sound indicating a defined operation or fault associated with the respective sound-generating object;
determining a change in the identified sound over time; and
identifying the fault condition associated with the respective sound-generating object based on the determined change in the identified sound over time.

10. The system of claim 1, wherein the first sound detection device includes circuitry to:
generate and output audible test signals;
detect sound including reflected test signals comprising reflections of the audible test signals output by the respective sound detection device and reflected off respective structures; and
generate test result signals based on the detected reflected test signals.

11. The system of claim 10, comprising logic instructions executable to, prior to testing the first location, determining the first location for the first sound detection device including:
receiving, via a user interface, location information for at least one sound-generating object in the defined space, the location information indicating a respective location of the at least one respective sound-generating object;
receiving test result signals generated by the first sound detection device positioned in at least one test location;
determining the first location for the first sound detection device based on (a) the received location information for the at least one sound-generating object and (b) the received test result signals generated by the first sound detection device positioned in at least one test location; and
outputting, via the user interface, the first location for the first sound detection device.

12. A method, comprising:
performing, by control circuitry of a sound-based monitoring system, a process to locate a first sound detection device in a defined space, including:
testing a first location for the first sound detection device by:
receiving sound data generated by the first sound detection device positioned at the first location;
analyzing the received sound data generated by the first sound detection device positioned at the first location to identify sound generated by a first sound-generating object;
analyzing a quality of the first location based on the analysis of the received sound data; and
based on the analyzed quality of the first location, outputting via a visual or audible output device, a user notification including at least one of (a) an instruction to relocate the first sound detection device or (b) an instruction to add a second sound detection device in the defined space.

13. The method of claim 12, comprising, prior to testing the first location, determining the first location for the first sound detection device by:
receiving, via a user interface, location information for at least one sound-generating object in the defined space, the location information indicating a respective location of the at least one sound-generating object;
determining the first location for the first sound detection device based on the received location information for the at least one sound-generating object; and
outputting, via the user interface, the first location for the first sound detection device.

14. The method of claim 12, wherein testing the first location for the first sound detection device includes:
analyzing the first location for detecting sounds from each of multiple sound-generating objects in a sequential manner, wherein analyzing the first location for detecting sounds from each respective sound-generating object comprises:
receiving sound data generated by the first sound detection device during a sound-generating operation of the respective sound-generating object;
analyzing the received sound data generated by the first sound detection device positioned at the first location to identify sound generated by the respective sound-generating object; and
analyzing a quality of the identified sound generated by the respective sound-generating object.

15. The method of claim 12, wherein performing the process includes:
receiving, via the user interface, dimensions of the defined space; and
generating a map of the defined space based at least on the received dimensions of the defined space, and locating the at least one sound-generating object in the map based on the received location information for the at least one sound-generating object.

16. The method of claim 12, comprising performing a monitoring process after the process, the monitoring process including:
identifying a fault condition associated with a respective sound-generating object based on sound data generated by the first sound detection device; and
outputting a notification of the identified fault condition associated with the respective sound-generating object.

17. The method of claim 16, wherein performing the monitoring process includes:
receiving user feedback indicating a rejection of the identified fault condition associated with the respective sound-generating object; and
in response to receiving the rejection of the identified fault condition, adjusting at least one fault detection parameter for identifying the fault condition associated with the respective sound-generating object.

18. The method of claim 16, wherein identifying the fault condition associated with the respective sound-generating object includes:
receiving sound data generated by the first sound detection device;
comparing the received sound data with reference sound data corresponding with the respective sound-generating object; and
identifying the fault condition associated with the respective sound-generating object based on the comparison of the received sound data with the reference sound data.

19. The method of claim 16, wherein identifying the fault condition associated with the respective sound-generating object includes:
receiving sound data generated by the first sound detection device;
identifying, from the received sound data, a sound indicating a defined operation or fault associated with the respective sound-generating object;
determining a duration of the identified sound; and
determining the duration of the identified sound exceeds a defined threshold duration for the identified sound.

20. The method of claim 12, wherein the first sound detection device includes circuitry to:
generate and output audible test signals;
detect sound including reflected test signals comprising reflections of the audible test signals output by the respective sound detection device and reflected off respective structures; and
generate test result signals based on the detected reflected test signals; and
wherein the method comprises, prior to testing the first location, determining the first location for the first sound detection device by:
receiving, via a user interface, location information for at least one sound-generating object in the defined space, the location information indicating a respective location of the at least one respective sound-generating object;
receiving test result signals generated by the first sound detection device positioned in at least one test location;
determining the first location for the first sound detection device based on (a) the received location information for the at least one sound-generating object and (b) the received test result signals generated by the first sound detection device positioned in at least one test location; and
outputting, via the user interface, the first location for the first sound detection device.
